(19) United States
(12) Patent Application Publication
(10) Pub. No.: US 2026/0132889 A1
(43) Pub. Date: May 14, 2026

(54) CONDENSATE WATER RECTIFIER

(71) Applicant: Tsutomu KATSURA, Tokyo (JP)

(72) Inventor: Tsutomu KATSURA, Tokyo (JP)

(73) Assignee: Tsutomu KATSURA, Tokyo (JP)

(21) Appl. No.: 19/382,982

(22) Filed: Nov. 7, 2025

(30) Foreign Application Priority Data
Nov. 11, 2024 (JP) 2024-196862
May 26, 2025 (JP) 2025-087583

(51) Int. Cl. F16T 1/38

(52) U.S. Cl. CPC F16T 1/383

(57) ABSTRACT

A condensate water rectifier in a steam flow passage includes a nozzle member having a first hole portion and a second hole portion that is continuous with and thicker than the first hole portion, and a partition wall separating an inlet and an outlet from each other, the inlet and the outlet communicating with each other via the first and second hole portions with the nozzle member attached to the partition wall. In the steam flow passage, the first hole portion is positioned on an upstream side and a vertically lower side of the second hole portion. The first hole portion opens in an attachment portion for attachment to the partition wall. 4r1≤L1, 1.5r1≤r2, and L1/3≤L2 hold where r1, L1, r2, and L2 denote the radius and length of the first hole portion and the radius and length of the second hole portion, respectively.

### CROSS-REFERENCE TO RELATED APPLICATION

This application is based upon and claims the benefit of priority from Japanese Patent Application No. 2024-196862, filed on Nov. 11, 2024 and the benefit of priority from Japanese Patent Application No. 2025-87583, filed on May 26, 2025; the entire contents of which are incorporated herein by reference.

### BACKGROUND

The present invention relates to a condensate water rectifier such as a steam trap.

In various facilities such as factories and offices that use steam as a heating source via a heat exchanger, a steam trap is used to automatically discharge a drain (condensate resulting from condensation of steam, that is, condensate water), which is generated in steam using equipment and a steam transport piping system between these pieces of equipment, to the outside of the system. This is to ensure appropriate temperature conditions in the steam using equipment such as a heating machine, a drying machine, or a heater that uses, in a heat exchanger unit, steam of a high temperature and a high pressure obtained in a boiler as well as the steam transport piping system that connects the boiler and the steam using equipment to each other. This is intended to be prevent the occurrence of a steam hammer phenomenon, for example.

There are various forms of steam traps. For example, mechanical steam traps in machine engineering (a bucket type and a float type), thermostatic steam traps (a bimetal type and a bellows type), and thermodynamic steam traps (disk type) can be cited as steam traps having a movable portion. In addition, steam traps having no particular movable portion include a nozzle type steam trap typified by an orifice nozzle type, a Venturi nozzle type, and a tunnel structure resistance tube type (see Japanese Patent No. 6942326, for example). This nozzle type steam trap is referred to as a fluidic steam trap and utilizes properties that water (liquid water) has a lower kinematic viscosity than steam when passing through a minute passage and that water flows approximately 30 times more easily than steam.

### SUMMARY

Now, when installed in a piping system through which a drain flows, a conventional nozzle type steam trap includes, in order from a downstream side, a drain inlet (inlet), a strainer, a Venturi nozzle, a drain water storage unit, and a discharge port (outlet) for discharge to the outside of a drain system, and the conventional nozzle type steam trap necessitates combining substantially the same number of parts as the above. Hence, the pipe diameter, length, and the like of the whole piping system often need to be adjusted in order to suitably accommodate pressure variation in portions upstream and downstream of the nozzle. That is, the nozzle type steam trap according to the conventional technology has a large number of parts and presents a difficulty in performing proper condensate water discharge management at a usage position unless information such as a steam flow rate and pressure variations in front and rear of the steam trap is sufficiently obtained. Furthermore, even when such information is obtained, there is a limit to suppression of leakage of steam unless the structure itself of the steam trap or the capacity of each part of the steam trap is altered. Thus, there is a desire for a condensate water rectifier, for example, a nozzle type steam trap, having a novel configuration that is less dependent on conditions at a usage position.

The present invention has been made in view of the above-described problems. It is an object of the present invention to provide a condensate water rectifier having a simpler configuration.

According to one aspect of the present invention, there is provided a condensate water rectifier that is provided in a steam flow passage and is configured to allow condensate water to flow from an inlet to an outlet, the condensate water rectifier including a nozzle member in which a first hole portion and a second hole portion that is continuous with the first hole portion and is thicker than the first hole portion are formed, and a partition wall provided to separate the inlet and the outlet from each other, the inlet and the outlet communicating with each other via the first hole portion and the second hole portion when the nozzle member is attached to the partition wall. In the steam flow passage, the first hole portion is positioned on an upstream side of the second hole portion and is positioned on a vertically lower side of the second hole portion.

Preferably, the first hole portion may open in an attachment portion, in the nozzle member, for attachment to the partition wall without having an enlarged diameter portion.

Preferably, an inside diameter of the first hole portion is dimensioned to suppress passage of steam and allow passage of the condensate water.

Preferably, letting r1 be a radius of the first hole portion, letting L1 be a length of the first hole portion, letting r2 be a radius of the second hole portion, and letting L2 be a length of the second hole portion, following relations may hold:

$$4 r 1 \leq L 1$$

$$1.5 r 1 \leq r 2$$

$$L 1 / 3 \leq L 2$$

Incidentally, a relation “L1≤20r1” may further hold.

Preferably, a recessed portion or a projecting portion for generating a rotating flow in a passing fluid is formed in at least either the first hole portion or the second hole portion.

Preferably, at least either an inner surface of the first hole portion or an inner surface of the second hole portion is formed of a plastic-based material.

Preferably, the nozzle member may be screwed to the partition wall.

Preferably, the outlet or a part on a downstream side of the outlet is configured to be bent in a direction intersecting an axial direction of the nozzle member.

Preferably, a fluid outflow start portion of the second hole portion in the nozzle member is positioned on a vertically upper side of a vertically lowermost portion of the outlet of a section in which the second hole portion is positioned.

Preferably, a fluid outflow start portion of the second hole portion in the nozzle member may be positioned on a vertically upper side of a vertically lowermost portion of the outlet of a section in which the second hole portion is positioned, and letting r1 be a radius of the first hole portion, letting L1 be a length of the first hole portion, letting r2 be a radius of the second hole portion, and letting L2 be a length of the second hole portion, following relations may hold:

$$4 r 1 \leq L 1$$

$$1.5 r 1 \leq r 2$$

$$L 1 / 3 \leq L 2$$

According to the foregoing one aspect of the present invention, since the foregoing configuration is provided, a condensate water rectifier having a simpler configuration than the conventional steam trap can be provided, and hence, it can be expected that such a condensate water rectifier be applied to various usage positions, for example.

### BRIEF DESCRIPTION OF THE DRAWINGS

FIG. 1 is a schematic diagram illustrating a steam piping system in which a steam trap according to a first embodiment of the present invention is disposed;

FIG. 2 is an enlarged sectional view of the steam trap in FIG. 1 and peripheries thereof;

FIG. 3 is a front view of a nozzle member in the steam trap in FIG. 1;

FIG. 4 is a front view of a nipple member in the steam trap in FIG. 1;

FIG. 5 is a front view of a strainer member in the steam trap in FIG. 1;

FIGS. 6A and 6B illustrate a modification of the steam trap according to the first embodiment, FIG. 6A being a sectional view of a nozzle member in the modification, and FIG. 6B being a sectional view of a part of a partition wall of a nipple member in the modification;

FIG. 7 is a sectional view of a steam trap according to a second embodiment of the present invention;

FIG. 8 is an enlarged view illustrating a relation between a nozzle member and an outlet in the steam trap in FIG. 7; and

FIG. 9 is a schematic diagram of assistance in explaining an experimental method.

### DETAILED DESCRIPTION OF THE PREFERRED EMBODIMENTS

Condensate water rectifiers according to embodiments of the present invention will hereinafter be described with reference to the drawings. A description will first be made of a nozzle type steam trap 10 as a condensate water rectifier according to a first embodiment.

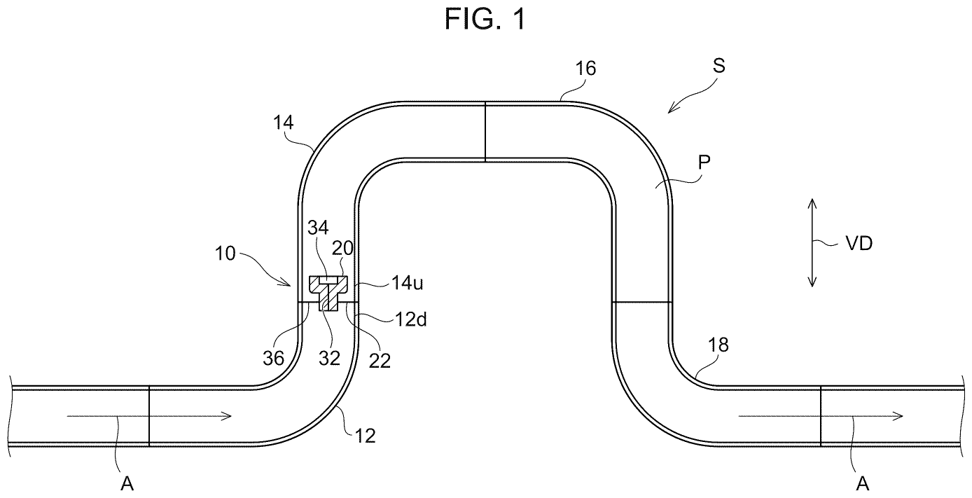

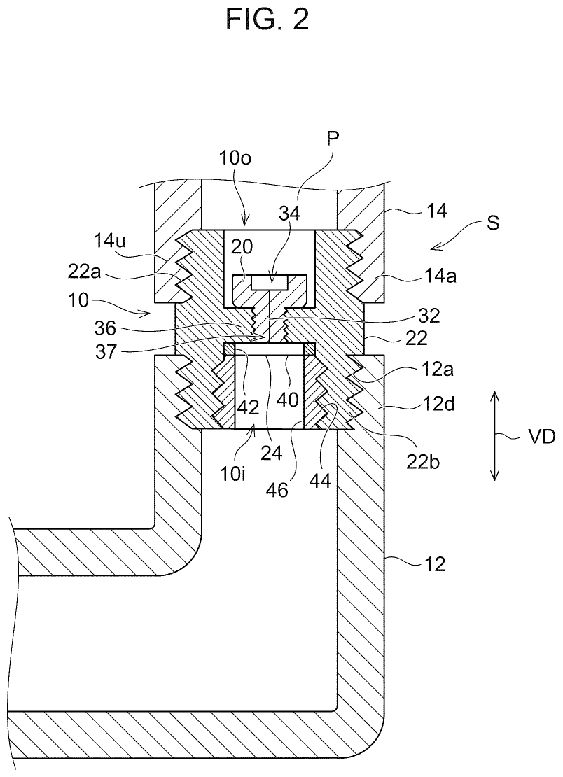

FIG. 1 illustrates a piping system S that defines a flow passage P through which steam flows (hereinafter referred to as a steam flow passage) and in which the steam trap 10 is disposed (which piping system will hereinafter be referred to as a steam piping system). FIG. 2 illustrates an enlarged sectional view of the steam trap 10 in the steam piping system S of FIG. 1 and parts in front and rear of the steam trap 10. Incidentally, in FIG. 1 and FIG. 2, the lower sides of paper planes thereof are regarded as a lower side in a vertical direction (arrow VD in the figures), and the upper sides of the paper planes are regarded as an upper side in the vertical direction.

Here, the steam piping system S has four joints 12, 14, 16, and 18. These joints 12, 14, 16, and 18 are each an L-shaped joint and are arranged in order from an upstream side in a flow direction A of steam or the like in the steam flow passage P of the steam piping system S. In FIG. 1, connecting portions of these joints 12, 14, 16, and 18 are illustrated in a simplified manner, and in this case, these joints are connected to one another by nipples (including a nipple member 22 to be described later). However, the connection of the joints 12, 14, 16, and 18 is not limited to this.

As illustrated in FIG. 1, a fluid that may include steam and a drain flows in the flow direction A. Thus, when the fluid reaches the joint 12, because the joint 12 is bent to the upper side in the vertical direction, the fluid flows upward in the vertical direction toward the joint 14. Then, because the joint 14 is bent to substantially a horizontal direction, the fluid flows while changing its course to substantially the horizontal direction. Further, because the joint 16 is bent to the lower side in the vertical direction, the fluid flows while changing its course to the lower side in the vertical direction, and reaches the joint 18. Because the joint 18 is bent to substantially the horizontal direction, the fluid that has reached the joint 18 flows in substantially the horizontal direction, that is, a direction of separating from the joint 12. Hence, the joints 12, 14, 16, and 18 form a substantially inverted U-shaped portion in the steam flow passage P of the steam piping system S.

The steam trap 10 is provided at a position of connection between the joint 12 and the joint 14 in the substantially inverted U-shaped portion in the steam flow passage P of the steam piping system S. The steam trap 10 is provided between the joint 12 on the most upstream side among the above joints and the joint 14 connected to the downstream side of the joint 12. At this position in the steam trap 10, the fluid flows from the lower side to the upper side in the vertical direction. Incidentally, in FIG. 1 and FIG. 2, the lower sides of the paper planes are regarded as the lower side in the vertical direction, and the upper sides of the paper planes are regarded as the upper side in the vertical direction. Thus, a downstream side end portion 12d of the joint 12 is oriented to the upper side in the vertical direction, and an upstream side end portion 14u of the joint 14 is oriented to the lower side in the vertical direction.

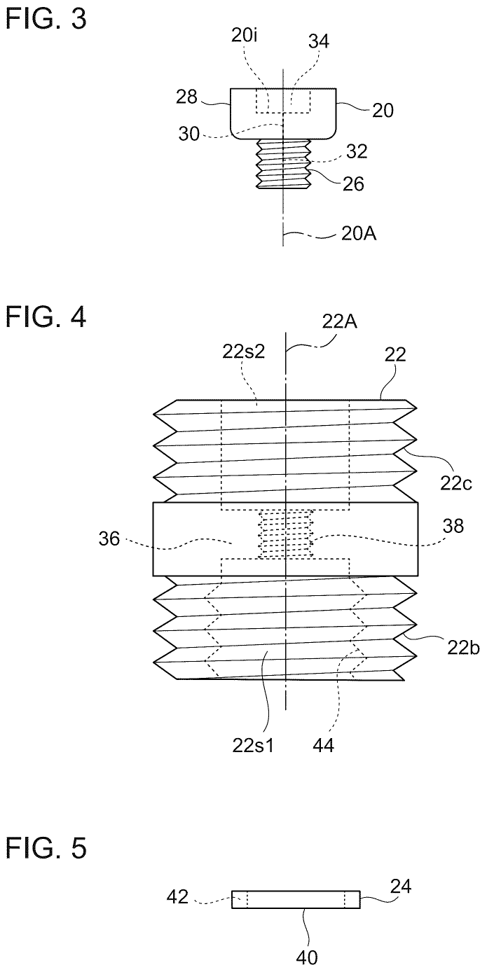

The steam trap 10 includes a nozzle member 20, a nipple member 22, and a strainer member 24. FIG. 3 illustrates the nozzle member 20. FIG. 4 illustrates the nipple member 22. FIG. 5 illustrates the strainer member 24.

As illustrated in FIGS. 1 to 3, the nozzle member 20 includes a male screw portion 26 and an expanded portion 28 continuous with the male screw portion 26, and these portions are arranged linearly. Hence, an axis 20A of the nozzle member 20 is an axis of the male screw portion 26 and is also an axis of the expanded portion 28. The nozzle member 20 has a nozzle hole 30 along the axis 20A, the nozzle hole 30 opening at both ends of the nozzle member 20. The nozzle hole 30 includes a first hole portion 32 and a second hole portion 34 that is a hole thicker than the first hole portion 32. The first hole portion 32 and the second hole portion 34 are directly continuous with each other. That is, the axis 20A of the nozzle member 20 is not only an axis of the first hole portion 32 but also an axis of the second hole portion 34, and in a direction of the axis 20A, the first hole portion 32 opens at one end on the male screw portion 26 side of the nozzle member 20 and extends beyond an overall length of the male screw portion 26 to a midpoint of the expanded portion 28, and the second hole portion 34 opens at another end on the expanded portion 28 side of the nozzle member 20 and extends to the midpoint of the expanded portion 28 to merge with the first hole portion 32. The design of the first hole portion 32 and the second hole portion 34 along the axis 20A is based on a viewpoint of rectification. Incidentally, the first hole portion 32 opens in an attachment portion 37, in the nozzle member 20, for attachment to a partition wall 36 to be described later, without having a further enlarged diameter portion.

The inside diameter of the first hole portion 32 of the nozzle member 20 is dimensioned to suppress the passage of steam and allow the passage of a drain, that is, liquid water, or in other words, condensate water. Then, in order to suppress the leakage of steam from the upstream side to the downstream side of the nozzle member 20 via the nozzle hole 30 while ensuring the flow of the condensate water in the nozzle hole 30 of the nozzle member 20, letting r1 be the radius of the first hole portion 32, letting L1 be the length of the first hole portion 32, letting r2 be the radius of the second hole portion 34, and letting L2 be the length of the second hole portion 34, respective relations of the following Equations (1) to (3) preferably hold.

$$4 r 1 \leq L 1 \qquad ( 1 )$$

$$1.5 r 1 \leq r 2 \qquad ( 2 )$$

$$L 1 / 3 \leq L 2 \qquad ( 3 )$$

Incidentally, with regard to the first hole portion 32, the length L1 preferably further satisfies a relation “L1≤20r1” with the radius r1, but this is not limitative.

Incidentally, an inner surface 20i that defines the nozzle hole 30 of the nozzle member 20 is formed of a plastic-based material. In this case, the nozzle member 20 is made of metal, and the nozzle hole 30 of the plastic-based material is formed by coating the nozzle member 20 with the plastic-based material. However, the whole nozzle member 20 may be formed of the plastic-based material. The inner surface 20i made of the plastic-based material that defines the nozzle hole 30 may be formed by various coating techniques or thin film forming techniques, or may be formed by fitting the plastic-based material that defines the nozzle hole 30 to the nozzle member 20. When an amine-based boiler compound (oil-based) is used to protect the steam piping system S itself, for example, there is a case where the compound is included in the fluid flowing through the steam flow passage P. In such a case, the flowability of the fluid can be enhanced by forming the nozzle hole 30 by the plastic-based material.

The nipple member 22 will be described on the basis of FIG. 2 and FIG. 4. The nipple member 22 is a joint member that connects the joint 12 and the joint 14 to each other. The nipple member 22 is a tubular threaded member, has an axis 22A extending in a longitudinal direction of the tubular threaded member, and includes a first male screw portion 22b that is screwed into a female thread 12a of the downstream side end portion 12d of the joint 12 and a second male screw portion 22c that is screwed into a female thread 14a of the upstream side end portion 14u of the joint 14. Moreover, the nipple member 22 has, on the inside thereof, the partition wall 36 that is substantially orthogonal to the axis 22A. The partition wall 36 is provided between the first male screw portion 22b and the second male screw portion 22c in the direction of the axis 22A. A female screw hole 38 is formed in the partition wall 36. The female screw hole 38 extends along the axis 22A and is configured such that the male screw portion 26 of the nozzle member 20 described earlier can be screwed into the female screw hole 38. The partition wall 36 defines, within the nipple member 22, a first recessed portion 22s1 opening in one end portion in the direction of the axis 22A on the first male screw portion 22b side and a second recessed portion 22s2 opening in another end portion in the direction of the axis 22A on the second male screw portion 22c side. These recessed portions 22s1 and 22s2 are connected to each other by the female screw hole 38. The nozzle member 20 is inserted into the second recessed portion 22s2, and the male screw portion 26 of the nozzle member 20 can be detachably screwed into the female screw hole 38 of the partition wall 36 of the nipple member 22. As illustrated in FIG. 2, when the nozzle member 20 is attached to the nipple member 22, the nozzle member 20 is completely housed within the nipple member 22. Then, in the steam trap 10, an open end portion of the first recessed portion 22s1 defines an inlet 10i of the fluid such as steam, and an open end portion of the second recessed portion 22s2 defines an outlet (or a discharge port) 10o of the fluid. That is, the nipple member 22 forms the inlet 10i and the outlet 10o of the steam trap 10. Incidentally, a female screw portion 44 is formed on an inner surface, particularly a tubular inside surface, of the first recessed portion 22s1.

The strainer member 24 will be described on the basis of FIG. 2 and FIG. 5. The strainer member 24 in this case includes a net 40. The strainer member 24 includes a frame portion 42, and the net 40 is stretched on the frame portion 42. As illustrated in FIG. 2, the frame portion 42 of the strainer member 24 is configured to be precisely fitted into the first recessed portion 22s1 of the nipple member 22. Incidentally, a tubular male screw member 46 that is screwed into the above-described female screw portion 44 formed on the inner surface of the nipple member 22 is used to fix the strainer member 24 to the nipple member 22.

The attachment of the steam trap 10 will be described on the basis of FIGS. 2 to 5.

First, the nozzle member 20 and the strainer member 24 are attached to the nipple member 22. The nozzle member 20 is attached to the nipple member 22 by screwing the male screw portion 26 of the nozzle member 20 into the female screw hole 38 of the partition wall 36 of the nipple member 22. When the nozzle member 20 is thus attached to the nipple member 22, the first recessed portion 22s1 of the nipple member 22 is connected to the second recessed portion 22s2 only via the nozzle hole 30 of the nozzle member 20, that is, the first hole portion 32 and the second hole portion 34. Then, the strainer member 24 is inserted, on the female screw portion 44 side of the nipple member 22, through the female screw portion 44 to come into contact with the partition wall 36. Moreover, the tubular male screw member 46 is screwed into the female screw portion 44. The strainer member 24 is thus sandwiched between the partition wall 36 and the tubular male screw member 46. Consequently, the fluid that has entered the inside of the first recessed portion 22s1 cannot reach the first hole portion 32 of the nozzle hole 30 unless passing through the net 40 of the strainer member 24. The nipple member 22 to which the nozzle member 20 and the strainer member 24 are thus attached is connected to the joint 12 and the joint 14 by screwing. At this time, the steam trap 10 is attached such that the first hole portion 32 is positioned on the upstream side of the second hole portion 34 and is positioned on the vertically lower side of the second hole portion 34.

In the thus provided steam trap 10, the nipple member 22 forms the outlet 10o of the steam trap 10, the outlet 10o being located on the vertically upper side of the second hole portion 34 in the steam flow passage P (see FIG. 2).

Moreover, because the joint 14 immediately on the downstream side of the steam trap 10 is an L-shaped joint, a part on the downstream side of the outlet 10o is configured to be bent in a direction intersecting the direction of the axis 20A of the nozzle member 20. However, the outlet 10o itself may be bent in the direction intersecting the direction of the axis 20A of the nozzle member 20. Alternatively, the second hole portion 34 of the nozzle member 20 may be provided with a horizontal hole extending in the direction intersecting the direction of the axis 20A of the nozzle member 20, and this horizontal hole may be set as an outlet. Thus, the outlet 10o is not limited to being located on the vertically upper side of the second hole portion 34, and may be located at substantially the same vertical position as the second hole portion 34 or on the vertically lower side of the second hole portion 34. In these cases, the outlet 10o preferably extends in the direction intersecting the axis 20A of the nozzle member 20, for example, a direction at a right angle to the axis 20A of the nozzle member 20.

In the following, a description will be made of actions and effects of the steam trap 10 that has the above-described configuration and is provided as described above.

As illustrated in FIG. 1 and FIG. 2, the steam trap 10 configured to allow a drain, that is, condensate water, to flow from the inlet 10i to the outlet 10o is provided to the steam flow passage P in the steam piping system S. The steam trap 10 includes the nozzle member 20 in which the first hole portion 32 and the second hole portion 34 are formed, the second hole portion 34 being continuous with the first hole portion 32 and thicker than the first hole portion 32, and the partition wall 36 provided to separate the inlet 10i and the outlet 10o from each other. When the nozzle member 20 is attached to the partition wall 36, the inlet 10i and the outlet 10o communicate with each other via the first hole portion 32 and the second hole portion 34. Moreover, in the steam flow passage P, the first hole portion 32 is positioned on the upstream side of the second hole portion 34 and is positioned on the vertically lower side of the second hole portion 34. Hence, because it is more difficult for steam to pass through the first hole portion 32 than the drain, the drain advantageously passes through the first hole portion 32. The retention of the drain in the second hole portion 34 can therefore be made to occur more suitably. It is thereby possible to suitably suppress the discharging of steam. Moreover, this steam trap 10 includes the nozzle member 20 having the above-described configuration and the partition wall 36 having the above-described configuration. The steam trap 10 thus has a very simple configuration. Hence, the steam trap 10 will be less dependent on conditions at a usage position than the conventional steam trap.

Moreover, because the nozzle member 20 is detachably attached to the partition wall 36, it is possible to prepare a plurality of kinds of nozzle members 20 in advance and select and attach a suitable nozzle member 20 according to the usage position. The plurality of kinds of nozzle members 20 include, for example, nozzle members 20 different from each other in capacity of the second hole portion 34.

In addition, in the steam trap 10, the inside diameter of the first hole portion 32 is dimensioned to suppress the passage of steam and allow the passage of a drain, that is, condensate water. Hence, it is possible to suppress the passage of steam in the first hole portion 32 more suitably and discharge the drain more suitably.

Moreover, the inner surface 20i that defines the nozzle hole 30 including the first hole portion 32 and the second hole portion 34 is formed of a plastic-based material. Hence, a flow of the fluid, for example, the drain, in the nozzle hole 30 can be made to occur more smoothly. It is to be noted that, while the inner surface 20i of the whole of the nozzle hole 30 is formed of a plastic material in this case, the present invention is not limited to this. At least either the inner surface of the first hole portion 32 or the inner surface of the second hole portion 34 may be formed of the plastic-based material.

In addition, in order to make a flow of the fluid, for example, a flow of the drain, in the nozzle hole 30 including the first hole portion 32 and the second hole portion 34 occur more suitably, a recessed portion or a projecting portion for generating a rotating flow in the passing fluid may be formed in at least either the first hole portion 32 or the second hole portion 34. For example, the recessed portion or the projecting portion may be formed in a helical shape. This causes the fluid, for example, the drain, to flow in such a manner as to be pressed against the recessed portion or projecting portion in the helical shape, so that the flow can be generated smoothly while adjusted more suitably.

Incidentally, in the above-described steam trap 10, the partition wall 36 is provided with the female screw hole 38, and the nozzle member 20 is screwed to the partition wall 36 by having the male screw portion 26 of the nozzle member 20 screwed into the female screw hole 38. However, the present invention is not limited to this.

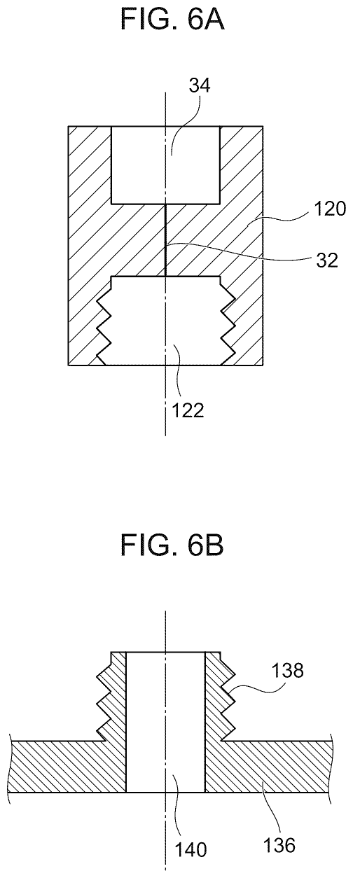

FIGS. 6A and 6B illustrate a nozzle member 120 (FIG. 6A) and a part of a partition wall 136 of a nipple member (FIG. 6B) in a steam trap as a modification. The nozzle member 120 has a first hole portion 32 and a second hole portion 34 as with the nozzle member 20, and further has a female screw hole 122 continuous with the first hole portion 32, the female screw hole 122 having a diameter larger than that of the first hole portion 32. The partition wall 136 is provided with a projecting portion having a male thread, that is, a male screw portion 138. A hole 140 is formed in the male screw portion 138. This hole 140 penetrates the partition wall 136. The nozzle member 120 may be attached to the partition wall 136 by having the male screw portion 138 of the partition wall 136 screwed into the female screw hole 122 of the nozzle member 120.

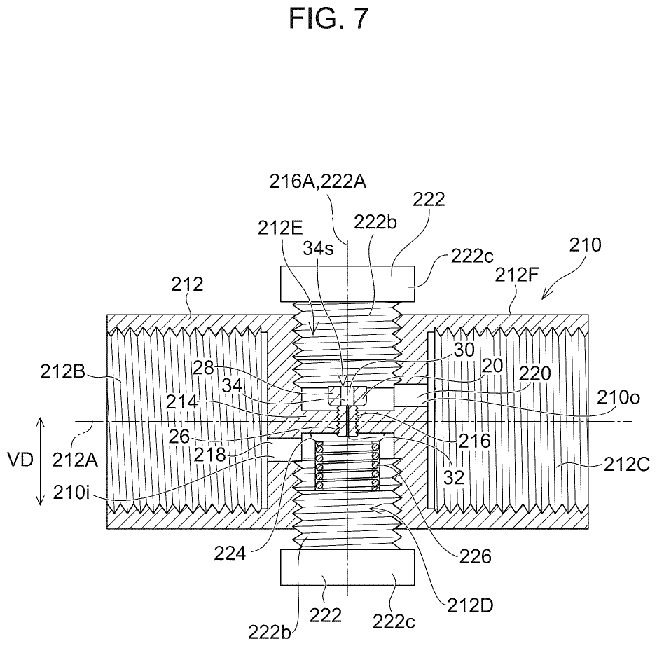

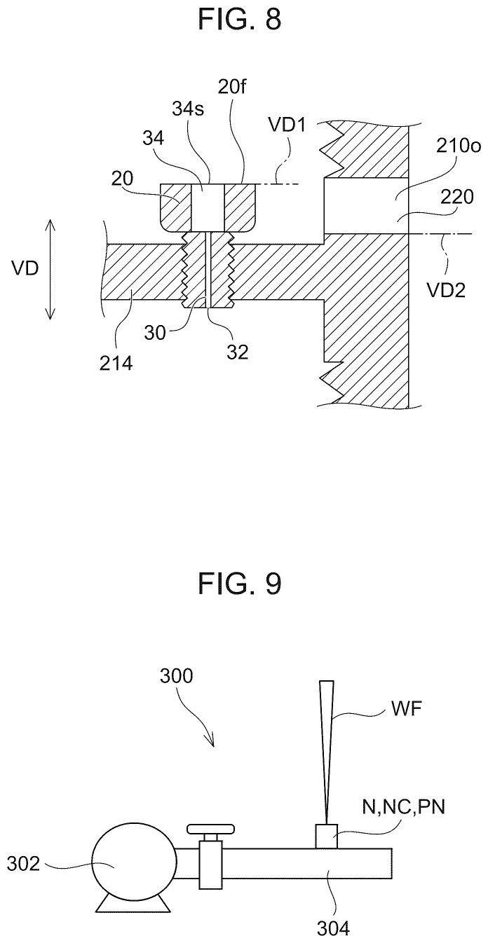

A nozzle type steam trap 210 as a condensate water rectifier according to a second embodiment will next be described on the basis of FIG. 7 and FIG. 8. In the following, a description will be made mainly of differences of the steam trap 210 according to the second embodiment from the steam trap 10 according to the first embodiment. Incidentally, the steam trap 210 similarly adopts the above-described nozzle member 20 and is used such that it has the positional relation between the first hole portion 32 and the second hole portion 34 and the like described in the first embodiment. However, the steam trap 210 is also capable of a modification or a change similar to that of the steam trap 10 as described on the basis of FIGS. 6A and 6B, for example.

The steam trap 210 has a housing 212 to which the above-described nozzle member 20 is attached. The housing 212 is a substantially cylindrical member, and has an axis 212A that extends linearly. At both ends of the housing 212 along the axis 212A, female screw holes 212B and 212C which open in end surfaces of corresponding end portions (hereinafter referred to as end portion screw holes) are formed. The end portion screw holes 212B and 212C each define a recessed portion having the axis 212A as a central axis thereof. Specifically, one end portion screw hole 212B is configured such that piping (not illustrated) on the upstream side of the steam piping system S is screwed into the one end portion screw hole 212B. The other end portion screw hole 212C is configured such that piping (not illustrated) on the downstream side of the steam piping system S is screwed into the other end portion screw hole 212C. While a piping attachment structure in the housing 212 thus adopts the end portion screw holes 212B and 212C, that is, female screws, there is no limitation to this, and various structures can be used. For example, a configuration which has male screws or flanges may be adopted. Incidentally, while the end portion screw holes 212B and 212C have the same shape and the same size, the end portion screw holes 212B and 212C may be different from each other in shape and size according to the piping to be connected.

Female screw holes (hereinafter referred to as radial direction screw holes) 212D and 212E which extend in a direction orthogonal to the axis 212A and are opposed to each other with a partition wall 214 interposed therebetween are formed between the end portion screw holes 212B and 212C in the direction of the axis 212A. Hence, the radial direction screw holes 212D and 212E each open in a peripheral side surface 212F of the housing 212. Incidentally, while the radial direction screw holes 212D and 212E have the same shape and the same size, the radial direction screw holes 212D and 212E may be different from each other in at least either shape or size.

The partition wall 214 is a flat plate-shaped part that extends along the axis 212A. A female screw hole (hereinafter referred to as a nozzle screw hole) 216 is formed in substantially the center of the partition wall 214. An axis 216A of the nozzle screw hole 216 is orthogonal to the axis 212A of the housing 212. However, in the present application, it is also possible that the axis 216A is inclined with respect to the axis 212A. The radial direction screw holes 212D and 212E communicate with each other via the nozzle screw hole 216.

The nozzle screw hole 216 and the radial direction screw holes 212D and 212E are formed such that the axis 216A of the nozzle screw hole 216 is the axis of each of the radial direction screw holes 212D and 212E. Moreover, the radial direction screw holes 212D and 212E, the partition wall 214, and the nozzle screw hole 216 are formed such that the axis 216A of the nozzle screw hole 216 directly intersects the axis 212A of the housing 212.

Two through holes 218 and 220 are formed to make these screw holes 212B, 212C, 212D, and 212E communicate with one another. Specifically, one through hole (hereinafter referred to as an upstream side through hole) 218 is formed to make the end portion screw hole 212B and the radial direction screw hole 212D communicate with each other. In addition, the other through hole (hereinafter referred to as a downstream side through hole) 220 is formed to make the end portion screw hole 212C and the radial direction screw hole 212E communicate with each other.

The upstream side through hole 218 extends substantially in parallel with the axis 212A but is formed at a position offset from the axis 212A, particularly, a position offset to such a degree as not to interfere with the partition wall 214. Similarly, the downstream side through hole 220 extends substantially in parallel with the axis 212A but is formed at a position offset from the axis 212A, particularly, a position offset to such a degree as not to interfere with the partition wall 214. Moreover, in this case, the upstream side through hole 218 and the downstream side through hole 220 are formed to have a symmetric relation with the partition wall 214 interposed therebetween.

As illustrated in FIG. 7, the steam trap 210 is disposed in the steam piping system S such that the axis 216A of the nozzle screw hole 216 extends substantially in the vertical direction VD and the radial direction screw hole 212E is positioned on the vertically upper side of the radial direction screw hole 212D. Furthermore, at this time, the upstream side through hole 218 is positioned on the vertically lower side of the partition wall 214, and the downstream side through hole 220 is positioned on the vertically upper side of the partition wall 214. Hence, when the nozzle member 20 is not attached to the partition wall 214, a fluid flowing from the upstream side can enter the inside of the housing 212 from the end portion screw hole 212B, enter the radial direction screw hole 212D via the upstream side through hole 218, enter the radial direction screw hole 212E via the nozzle screw hole 216 on the vertically upper side of the radial direction screw hole 212D, and flow out to the end portion screw hole 212C via the downstream side through hole 220.

The nozzle member 20 is screwed and attached to the nozzle screw hole 216 of the partition wall 214. Thus, the male screw portion 26 of the nozzle member 20 is screwed in the nozzle screw hole 216, and the expanded portion 28 continuous with the male screw portion 26 can be positioned in the radial direction screw hole 212E. Moreover, in the steam trap 210 illustrated in FIG. 7, the first hole portion 32 of the nozzle member 20 is positioned on the upstream side of the second hole portion 34 and is positioned on the vertically lower side of the second hole portion 34.

An opening portion of each of the radial direction screw holes 212D and 212E is closed by a plug member 222. The plug member 222 has an axis 222A and includes a male screw portion 222b that is screwed into the radial direction screw hole 212D or 212E and a gripping portion 222c that is continuous with the male screw portion 222b. The axis 222A of the plug member 222 is also an axis of the male screw portion 222b and is also an axis of the gripping portion 222c.

In the steam trap 210, the radial direction screw hole 212D is positioned on the upstream side of the radial direction screw hole 212E and is positioned on the vertically lower side of the radial direction screw hole 212E. In the radial direction screw hole 212D, a strainer member 224 is disposed between the partition wall 214 and the plug member 222. In this case, the strainer member 224 is formed as a net itself. However, the strainer member 224 may have a configuration same as that of the strainer member 24.

The strainer member 224 is disposed to directly face the first hole portion 32 of the nozzle hole 30 of the nozzle member 20 attached to the nozzle screw hole 216. A spring member 226 as an elastic member is disposed between the strainer member 224 and the plug member 222. When the plug member 222 closes the radial direction screw hole 212D, the spring member 226 abuts against the plug member 222 and receives a pressing force. Hence, the spring member 226 is elastically deformed by compression and presses the strainer member 224 against the partition wall 214, thereby covering the first hole portion 32 of the nozzle hole 30 of the nozzle member 20 attached to the nozzle screw hole 216. The fluid that has reached the radial direction screw hole 212D thus reaches the first hole portion 32 via the strainer member 224.

In the steam trap 210 having the above-described configuration, a section in which the first hole portion 32 in the nozzle member 20 is positioned, that is, a section into which the first hole portion 32 opens, is substantially the radial direction screw hole 212D, an inlet 210i to the radial direction screw hole 212D is the upstream side through hole 218, a section in which the second hole portion 34 in the nozzle member 20 is positioned, that is, a section into which the second hole portion 34 opens, is the radial direction screw hole 212E, and an outlet 210o from the radial direction screw hole 212E is the downstream side through hole 220. This steam trap 210 has such a feature that a fluid outflow start portion 34s of the second hole portion 34 in the nozzle member 20 is positioned on the vertically upper side of a vertically lowermost portion of the downstream side through hole 220 as the outlet 210o of the radial direction screw hole 212E which is the section in which the second hole portion 34 is positioned.

Here, a reference will be made to FIG. 8, which illustrates, in an extracted state, the nozzle member 20 and the downstream side through hole 220 in the steam trap 210 of FIG. 7. The fluid outflow start portion 34s of the second hole portion 34 in the nozzle member 20 refers to a part where the fluid that has flowed through the nozzle hole 30 from the first hole portion 32 to the second hole portion 34 in the nozzle member 20 starts to flow out of the second hole portion 34. Specifically, in this case, the fluid outflow start portion 34s is an end surface 20f of the nozzle member 20 on the second hole portion 34 side, and the position of the fluid outflow start portion 34s in the vertical direction VD corresponds to a line VD1 in FIG. 8.

Meanwhile, the vertically lowermost portion of the outlet 210o of the section in which the second hole portion 34 is positioned, that is, the downstream side through hole 220, refers to a part positioned on the lowermost side in the vertical direction in a region of the downstream side through hole 220 through which region the fluid can flow. The position of the vertically lowermost portion in the vertical direction VD corresponds to a line VD2 in FIG. 8. As is clear from FIG. 8, in the vertical direction VD, the line VD1 is positioned on the upper side of the line VD2.

Hence, the fluid that has passed through the nozzle hole 30 of the nozzle member 20 from the first hole portion 32 to the second hole portion 34 and flowed out of the second hole portion 34 does not stay on the vertically upper side of the second hole portion 34 but flows out from the downstream side through hole 220 as the outlet 210o. That is, the amount of the fluid accumulated in such a manner as to seal the first hole portion 32 is limited to the capacity of the second hole portion 34. It is thus possible to further enhance a rectifying effect when the fluid passes through the nozzle hole 30.

Incidentally, the housing 212 of the steam trap 210 is fabricated by cutting a substantially cylindrical member. However, the housing 212 may be fabricated by combining a plurality of members with each other.

### (Example of Experiment)

Here, relations between dimensions of the first hole portion 32 (radius: r1, length: L1) and dimensions of the second hole portion 34 (radius: r2, length: L2) in the nozzle hole 30 of the nozzle member 20 were evaluated by experiment. A result thereof will be described on the basis of FIG. 9 and Table 1.

FIG. 9 schematically illustrates an evaluation device 300. In the present experiment, a pipe 304 having a distal end thereof closed was connected to a pump 302 whose water supply pressure (flow rate) is variable, experimental nozzles N were attached to a midpoint of the pipe 304, and discharged water flows WF from the experimental nozzles N were observed and evaluated. A comparative nozzle NC among the experimental nozzles N was a one-stage nozzle whose nozzle hole includes only a hole corresponding to the above-described first hole portion 32. Present nozzles PN among the experimental nozzles N were each a two-stage nozzle having the first hole portion 32 and the second hole portion 34 and were fabricated in various dimensions.

Table 1 indicates the respective dimensions of the present nozzles PN from nozzle number 1 to 28, degrees of satisfaction of each of the above-described Equations (1) to (3), and evaluation results. Incidentally, as for the degrees of satisfaction of the above-described Equations (1) to (3), a case where an equation was satisfied was denoted by “Satisfied,” and a case where an equation was not satisfied was denoted by “Not satisfied.” Moreover, a present nozzle PN whose discharged water flow WF was spread or disturbed less than the comparative nozzle NC was construed as having an excellent rectifying effect and was evaluated as “Excellent” in Table 1, a present nozzle PN whose discharged water flow WF was spread or disturbed to substantially the same degree as the comparative nozzle NC was evaluated as “Good” in Table 1, and a present nozzle PN whose discharged water flow WF was spread or disturbed more than the comparative nozzle NC was evaluated as “Poor” in Table 1.

As indicated in Table 1, the nozzles with which all the relations of the above-described Equations (1) to (3) were satisfied obtained evaluations of “Excellent” or “Good.”

TABLE 1

| | 1st hole portion | | 2nd hole portion | | | | | |
|---|---|---|---|---|---|---|---|---|
| Nozzle | r1 | L1 | r2 | L2 | (1) | (2) | (3) | |
| number | (mm) | (mm) | (mm) | (mm) | 4r1 ≤ L1 | 1.5r1 ≤ r2 | L1/3 ≤ L2 | Evaluation |
| 1 | 0.6 | 2.0 | 2.0 | 3.0 | Not satisfied | Satisfied | Satisfied | Poor |
| 2 | 0.6 | 3.0 | 2.0 | 3.0 | Satisfied | Satisfied | Satisfied | Excellent |
| 3 | 0.6 | 4.0 | 2.0 | 3.0 | Satisfied | Satisfied | Satisfied | Good |
| 4 | 0.6 | 4.0 | 3.0 | 3.0 | Satisfied | Satisfied | Satisfied | Good |
| 5 | 0.6 | 4.0 | 4.0 | 3.0 | Satisfied | Satisfied | Satisfied | Excellent |
| 6 | 0.6 | 5.0 | 2.0 | 3.0 | Satisfied | Satisfied | Satisfied | Good |
| 7 | 0.6 | 5.0 | 3.0 | 3.0 | Satisfied | Satisfied | Satisfied | Excellent |
| 8 | 0.6 | 5.0 | 4.0 | 3.0 | Satisfied | Satisfied | Satisfied | Excellent |
| 9 | 0.6 | 5.0 | 2.0 | 4.0 | Satisfied | Satisfied | Satisfied | Excellent |
| 10 | 0.6 | 5.0 | 3.0 | 4.0 | Satisfied | Satisfied | Satisfied | Excellent |
| 11 | 0.6 | 5.0 | 4.0 | 4.0 | Satisfied | Satisfied | Satisfied | Excellent |
| 12 | 1.0 | 8.0 | 1.5 | 2.0 | Satisfied | Satisfied | Not satisfied | Poor |
| 13 | 1.0 | 8.0 | 2.0 | 2.0 | Satisfied | Satisfied | Not satisfied | Poor |
| 14 | 1.0 | 8.0 | 2.0 | 3.0 | Satisfied | Satisfied | Satisfied | Good |
| 15 | 1.0 | 8.0 | 3.0 | 3.0 | Satisfied | Satisfied | Satisfied | Excellent |
| 16 | 1.0 | 8.0 | 4.0 | 3.0 | Satisfied | Satisfied | Satisfied | Excellent |
| 17 | 1.0 | 8.0 | 2.0 | 5.0 | Satisfied | Satisfied | Satisfied | Excellent |
| 18 | 1.0 | 8.0 | 3.0 | 5.0 | Satisfied | Satisfied | Satisfied | Excellent |
| 19 | 1.0 | 8.0 | 4.0 | 5.0 | Satisfied | Satisfied | Satisfied | Excellent |
| 20 | 2.0 | 8.0 | 3.0 | 3.0 | Satisfied | Satisfied | Satisfied | Good |
| 21 | 2.0 | 8.0 | 4.0 | 3.0 | Satisfied | Satisfied | Satisfied | Excellent |
| 22 | 2.0 | 8.0 | 5.0 | 3.0 | Satisfied | Satisfied | Satisfied | Excellent |
| 23 | 2.0 | 9.0 | 3.0 | 3.0 | Satisfied | Satisfied | Satisfied | Good |
| 24 | 2.0 | 9.0 | 4.0 | 3.0 | Satisfied | Satisfied | Satisfied | Excellent |
| 25 | 2.0 | 9.0 | 5.0 | 3.0 | Satisfied | Satisfied | Satisfied | Excellent |
| 26 | 2.5 | 10.0 | 3.0 | 4.0 | Satisfied | Not satisfied | Satisfied | Poor |
| 27 | 2.5 | 10.0 | 3.5 | 4.0 | Satisfied | Not satisfied | Satisfied | Poor |
| 28 | 2.5 | 10.0 | 4.0 | 4.0 | Satisfied | Satisfied | Satisfied | Excellent |

With the conventional technology, it is difficult to alter the steam trap to be installed, according to an obvious steam amount or a change in the steam amount. Meanwhile, in order to avoid a situation in which a drain is accumulated but is not discharged in the conventional nozzle type steam trap, it is inevitable, in selecting the diameter of the nozzle, to select a nozzle having an appropriate diameter according to the maximum drain generation amount at a trap installation position. That is, in some conventional nozzle type steam traps, the nozzle diameter is larger than necessary in most time periods during which the drain generation amount is less than the maximum drain generation amount, and such steam traps are used in a state that is to be regarded as a state of partial steam leakage. In the time periods during which the drain generation amount is less than the maximum drain generation amount, part of the steam may leak from a distal end portion of the nozzle. If the flow at the drain discharge port is disturbed, there arises a need for further increasing the nozzle diameter for discharge. The amount of steam leakage is consequently increased.

If the steam leakage at the time of discharging the drain of far below the maximum drain amount cannot be reduced, a leakage steam reducing effect that is normally expected from the nozzle type steam trap cannot be expected. Even in the case of a drain mixed with steam, the nozzle diameter can be reduced when the fluid can be rectified without causing a turbulent flow.

As described above, in the embodiments according to the present invention, the nozzle member 20 provided to the partition wall 36 or 214 has the above-described first hole portion 32 and the above-described second hole portion 34. Moreover, letting r1 be the radius of the first hole portion 32, letting L1 be the length of the first hole portion 32, letting r2 be the radius of the second hole portion 34, and letting L2 be the length of the second hole portion 34, the respective dimensional relations of Equations (1) to (3) described above are desired to hold. The experimental result of Table 1 indicates that such a nozzle structure and dimensional relations according to the present invention are very effective in enhancing the rectifying effect and can therefore enhance the leakage steam reducing effect that is expected from a nozzle type steam trap.

The embodiments and the modifications thereof have been described above. However, the present invention is not limited to these. Various substitutions and changes are possible unless departing from the spirit and scope of the present invention defined by the claims of the present application.

Incidentally, the second hole portion 34 of the nozzle member 20 may be a hole with which a tool such as a hexagonal wrench engages. This enables the nozzle member 20 to be attached to or removed from the partition wall 36 or 214 more suitably.

In addition, while one steam trap 10 or 210 is provided to the steam piping system S in the foregoing embodiments, a plurality of steam traps 10 or 210 may be serially provided at a certain interval. In this case, in a steam trap 10 or 210 on a more upstream side, the first hole portion 32 may have a larger diameter.

What is claimed is:

1. A condensate water rectifier that is provided in a steam flow passage and is configured to allow condensate water to flow from an inlet to an outlet, the condensate water rectifier comprising:
a nozzle member in which a first hole portion and a second hole portion that is continuous with the first hole portion and is thicker than the first hole portion are formed; and
a partition wall provided to separate the inlet and the outlet from each other, the inlet and the outlet communicating with each other via the first hole portion and the second hole portion when the nozzle member is attached to the partition wall, wherein,
in the steam flow passage, the first hole portion is positioned on an upstream side of the second hole portion and is positioned on a vertically lower side of the second hole portion,
the first hole portion opens in an attachment portion, in the nozzle member, for attachment to the partition wall without having an enlarged diameter portion, and,
letting r1 be a radius of the first hole portion, letting L1 be a length of the first hole portion, letting r2 be a radius of the second hole portion, and letting L2 be a length of the second hole portion, following relations hold:
$$4 r 1 \leq L 1$$
$$1.5 r 1 \leq r 2$$
$$L 1 / 3 \leq L 2$$

2. The condensate water rectifier according to claim 1, wherein
an inside diameter of the first hole portion is dimensioned to suppress passage of steam and allow passage of the condensate water.

3. The condensate water rectifier according to claim 1, wherein
a recessed portion or a projecting portion for generating a rotating flow in a passing fluid is formed in at least either the first hole portion or the second hole portion.

4. The condensate water rectifier according to claim 1, wherein
at least either an inner surface of the first hole portion or an inner surface of the second hole portion is formed of a plastic-based material.

5. The condensate water rectifier according to claim 1, wherein
the nozzle member is screwed to the partition wall.

6. The condensate water rectifier according to claim 1, wherein
the outlet or a part on a downstream side of the outlet is configured to be bent in a direction intersecting an axial direction of the nozzle member.

7. The condensate water rectifier according to claim 1, wherein
a fluid outflow start portion of the second hole portion in the nozzle member is positioned on a vertically upper side of a vertically lowermost portion of the outlet of a section in which the second hole portion is positioned.
